(19) United States
(12) Patent Application Publication
(10) Pub. No.: US 2017/0208993 A1
(43) Pub. Date: Jul. 27, 2017

(54) Rotatable Roasting Spit

(71) Applicant: Mark Edward OHLMANN, Leduc (CA)

(72) Inventor: Mark Edward OHLMANN, Leduc (CA)

(21) Appl. No.: 15/006,942

(22) Filed: Jan. 26, 2016

(51) Int. Cl. A47J 37/04; A23L 5/10

(52) U.S. Cl. CPC A47J 37/049; A23L 5/15

(57) ABSTRACT

A roasting spit for cooking food items over a fire, the roasting spit having a fishing rod handle having upper and lower ends; a fishing rod section extending longitudinally from the upper end of the fishing rod handle and having a perpendicular guide loop in proximity to its upper end; a fishing reel having a reel foot attached in proximity to the lower end of the fishing rod handle, a reel body attached to the reel foot, a reel handle rotatably attached to the reel body, a rotating head rotatably attached to the reel body, a line spool, a line spool nut centrally positioned in the rotating head, a reel cover having a central opening, and a rotatable roasting spit attached at a first end to the line spool nut, extending upwardly through the central opening of the reel cover and through the guide loop, and having a food attachment zone at its upper end.

### FIELD OF THE INVENTION

The present invention relates to outdoor cooking. In particular, the present invention relates to spits for roasting food items.

### BACKGROUND OF THE INVENTION

It is widely known in the prior art to provide various rods for roasting a hot dog, marshmallow or other food item over a camp fire or similar heat source. Commonly, a branch has been sharpened and used to suspend the food item over the fire. However, as wood is flammable, such rods risk catching fire while in use. Such sticks also do not last long and the user must seek out a new roasting spit each time a campfire is made.

A non-flammable spit such as a metal rod may be used to provide a re-usable roasting spit. As metals are good heat conductors, an insulating handle is required to prevent burning of the hand during use. Even with a metal rod, however, the food item being cooked must be manually rotated to ensure even cooking throughout, and avoid burning of one side while the opposite side remains uncooked. Manual rotation may be awkward, usually required two hands, and may result in the food item and roasting spit being dropped into or alongside the fire.

It is desirable, therefore, to provide a non-flammable roasting spit which is rotatable about its longitudinal axis using only one hand.

### BRIEF DESCRIPTION OF THE DRAWINGS

A detailed description of the preferred embodiments is provided by way of example only and with reference to the following drawings, in which:

FIG. 1 is an isometric view of the roasting spit of the present invention; and

FIG. 2 is an isometric view of the roasting spit of the present invention with the reel cap removed to show the point of attachment of the roasting spit to a fishing reel.

In the drawings, several embodiments of the invention are illustrated by way of example. It is to be expressly understood that the description and drawings are only for the purpose of illustration and as an aid to understanding, and are not intended as a definition of the limits of the invention.

### SUMMARY OF THE INVENTION

There is provided a roasting spit for cooking food items over a fire, the roasting spit comprising a fishing rod handle 2 having upper 4 and lower 6 ends; a fishing rod section 8 extending longitudinally from the upper end of the fishing rod handle and having a perpendicular guide loop 10 in proximity to its upper end; a fishing reel 12 having a reel foot 14 attached in proximity to the lower end of the fishing rod handle, a reel body 16 attached to the reel foot, a reel handle 18 rotatably attached to the reel body, a rotating head 20 rotatably attached to the reel body, a line spool nut 22 centrally positioned in the rotating head, a line spool within the reel body (not shown), and a reel cover 24 having a central opening, and a rotatable roasting spit 26 attached at a first end to the line spool nut, extending upwardly through the central opening in the reel cover and through the guide loop, and having a food attachment zone 28 at its upper end.

The upper end of the roasting spit may have two or more parallel prongs or a metal cage for holding food items.

According to a method of use of the rotatable roasting spit of the present invention, the method includes the steps of placing the food item onto the upper end of the roasting spit; suspending the upper end of the roasting spit bearing the food item over a fire; rotating the fishing reel handle with one hand to cause axial rotation of the food item over the fire; and removing the food item from above the fire once a desired degree of cooking is achieved.

### DETAILED DESCRIPTION OF THE INVENTION

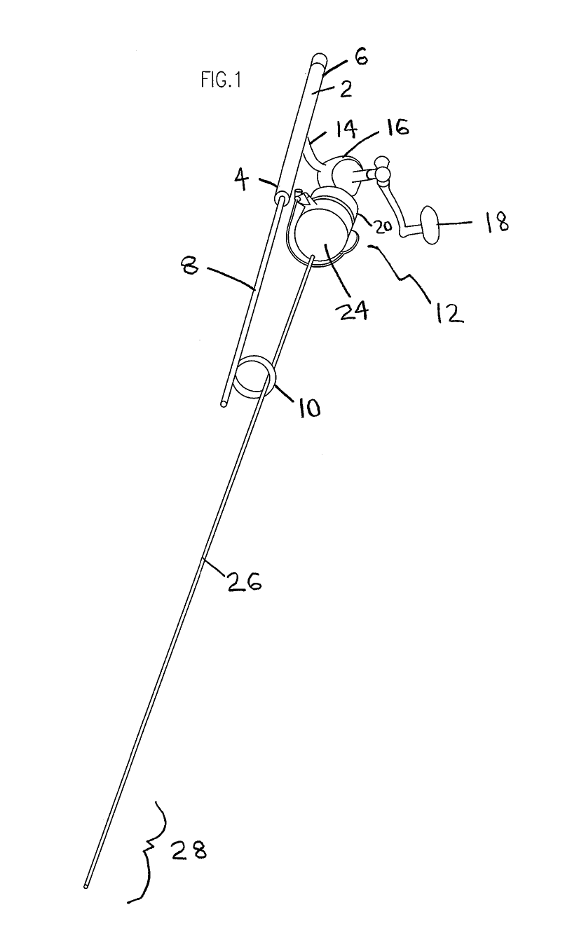

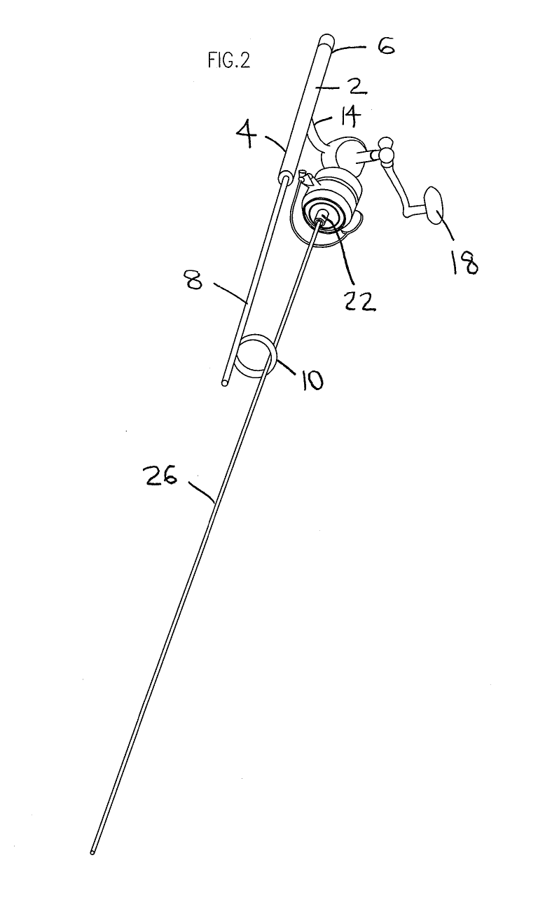

As depicted in FIGS. 1 and 2, there is provided an rotatable roasting spit for cooking food items over a fire.

The invention comprises a prior art fishing rod handle 2 having upper 4 and lower 6 ends; a cylindrical fishing rod section 8 extending longitudinally from the upper end of the handle and having a guide loop 10 at its distal end; a fishing reel 12 attached to the handle in proximity to the lower end; and a rotatable roasting spit 26 extending upwardly from the central line spool nut 22 within the rotating head 20 of the reel.

The rotatable roasting spit preferably is 100-125 cm long. According to one embodiment, at the lower end of the roasting spit there is provided threading which corresponds to threading inside the line spool nut of the reel. The fishing rod section preferably extends 60-90 cm from the fishing rod handle. The roasting spit extends from the reel and passes through the guide loop on the distal end of the fishing rod section.

In operation, the distal end of the roasting spit is inserted through the centre of a hot dog, marshmallow, or other food item and suspended over a fire. As the food item is cooked, the user may rotate the handle of the fishing reel, causing the rotating head of the reel to rotate, thereby also rotating the roasting spit.

In the preferred embodiment, the distal end of the roasting spit is a single cylindrical rod. However, other embodiments are possible such as an end attachment having two or more parallel prongs for attachment of food items, or a wire cage for roasting of vegetables or fish, for example.

In its simplest form, the invention is a machine for rotating a food item over a fire in which rotation of an actuator handle in a first plane engages a gear mechanism to cause axial rotation in a second plane perpendicular to the first plane of a shaft and an attached co-axial roasting spit.

Various dimensions of the roasting spit and fishing rod are possible and are understood to be included in the scope of the invention.

It will be appreciated by those skilled in the art that other variations of the preferred embodiment may also be practiced without departing from the scope of the invention.

1. A roasting spit for cooking food items over a fire, the roasting spit comprising:
a. a fishing rod handle having upper and lower ends;
b. a fishing rod section extending longitudinally from the upper end of the fishing rod handle and having a perpendicular guide loop in proximity to its upper end;
c. a fishing reel having a reel foot attached in proximity to the lower end of the fishing rod handle, a reel body attached to the reel foot, a reel handle rotatably attached to the reel body, a rotating head rotatably attached to the reel body, a line spool nut centrally positioned in the rotating head, and a reel cover having a central opening
d. a rotatable roasting spit attached at a first end to the line spool nut, extending upwardly through the guide loop, and having a food attachment zone at its upper end.

2. The roasting spit of claim 1, wherein the upper end of the roasting spit comprises two or more parallel prongs for holding food items.

3. The roasting spit of claim 1, wherein the upper end of the roasting spit comprises an openable wire cage for holding food items.

4. A method of cooking a food item over a fire using the roasting spit of claim 1, comprising the steps of:
a) placing the food item onto the upper end of the roasting spit;
b) suspending the upper end of the roasting spit bearing the food item over a fire;
c) rotating the fishing reel handle with one hand to cause axial rotation of the food item over the fire; and
d) removing the food item from above the fire once a desired degree of cooking is achieved.

5. A machine for rotating a food item over a fire, the machine having an actuator handle rotatable in a first plane which engages gears to effect axial rotation of a shaft and a co-axial roasting spit in a second plane perpendicular to the first plane, the roasting spit having a food attachment zone at its distal end.
